(19) United States
(12) Patent Application Publication
(10) Pub. No.: US 2017/0196166 A1
(43) Pub. Date: Jul. 13, 2017

(54) WHEELED SUPPORT FOR A GRASS TRIMMER OR BRUSH CUTTER

(71) Applicant: Zbigniew Filipowers, Naples, FL (US)

(72) Inventor: Zbigniew Filipowers, Naples, FL (US)

(21) Appl. No.: 15/076,628

(22) Filed: Mar. 21, 2016

Related U.S. Application Data
(60) Provisional application No. 62/231,859, filed on Jul. 17, 2015.

(51) Int. Cl. A01D 34/68; A01D 34/416; A01D 34/73; B60B 33/04

(52) U.S. Cl. CPC A01D 34/68; B60B 33/04; A01D 34/416; A01D 34/733

(57) ABSTRACT

A wheeled support for a grass trimmer or brush cutter is provided, including a support body integrally formed or removably attached to the grass trimmer or brush cutter and two preferably omnidirectional swivel caster wheels attached to a bottom of the support body. The support body can have a variety of different shapes and structures and can be attached to a shaft or a safety guard of the grass trimmer or brush cutter. The support body can also be integrally formed in the safety guard. More than one wheeled support can also be used for one grass trimmer or brush cutter; for instance, one support can be attached to the shaft and one can be attached to the safety guard. Alternatively, two different wheeled supports may be attached to the shaft at different locations.

### CROSS-REFERENCE TO RELATED APPLICATION

This application claims the benefit of co-pending U.S. Provisional Patent Application Ser. No. 62/231,859, filed Jul. 17, 2015, which is incorporated herein in its entirety.

### FIELD OF THE INVENTION

The present invention relates generally to lawn maintenance devices, and more particularly, to a wheeled device to be attached to a grass trimmer or brush cutter to provide support to the grass trimmer and to facilitate moving around of the grass trimmer so as to alleviate the fatigue of the operator of the grass trimmer.

### BACKGROUND OF THE INVENTION

String trimmers, also known as weed whackers, weed eaters, or weed whips, were invented during the 1970's as a way to more easily trim grasses around trees, bushes, flowers, fences, mailboxes, and structures. Instead of kneeling down with a pair of scissor-like hand trimmers which have been used by gardeners to arduously clip their gardens and lawns for centuries, the job could now be accomplished with relative ease by walking next to the desired cutting area and extending a pole containing a cutting head with a motor-driven spool of monofilament line designed to efficiently and easily cut weeds and grasses. In addition to monofilament line, other cutting materials used include plastic and metal blades and chains. However, the monofilament line is by far the most prevalent material used for cutting the grass and weeds. In addition to cutting weeds and grass, the configuration of a powered cutting head attached to a pole can be applied to a hedge trimmer, brush cutter, and a cultivator. In fact, there are string trimmers that are sold as “combo kits,” that contain a separate brush cutting blade that can be interchanged with a string cutting head to give it greater versatility.

Most of the above-mentioned cutting tools are powered by gasoline motors. There are also machines that use electric power. These electric machines are lighter but require an electrical cord attachment which limits their maneuverability since the cord has to be untangled and unattached from various items as it drags across the ground. Electric machines including an integrated battery are also known in the art, and are heavy and often bulky due to the added battery. In general, electric models are also typically less powerful than their gasoline counterparts, leading to decreased performance and limiting them to light-duty jobs.

Gasoline-powered cutting tools for the most part have two-stroke engines that use a mixture of oil and gasoline and are extremely polluting. Some gasoline-powered cutting tools now have four-stroke engines that use gasoline only. These engines are more powerful and less polluting; however, they are typically much heavier and can cause worker fatigue from the excess weight of the engine. The machine must be moved back and forth and sideways, while holding it at a constant height, and leading to repetitive movements by the arms, hands and shoulders, which could cause a stress or wearing type of injury such as carpal tunnel syndrome.

For really heavy duty jobs, there is still another type of trimmer—the walk-behind trimmer. This resembles a lawn mower in that it has two large wheels in the back and a metal cutting deck similar to a small mower, which contains a trimmer head with much heavier monofilament line or cutting blades. These machines are extremely powerful and can handle larger jobs that a typical string trimmer cannot. However, these machines are heavy and difficult to maneuver and are thus not practical for homeowners to use for their residential properties which typically do not have a large enough yard for this type of trimmer. Further, these machines are very expensive, costing up to ten times more than an average trimmer.

As stated above, when using a trimmer, operator fatigue can occur. This may become very dangerous since a tired operator might move the cutter in an unsafe manner, increasing the danger of striking an unintended object, or injuring himself. Some trimmers include shoulder or back straps to alleviate the fatigue. However, even with these straps, holding a trimmer for a long period of time while trying to maintain a certain height can still lead to strain on the arms, hands and shoulders of the operator and thus cause fatigue.

The machines can also cut erratically since it can be difficult to maintain an even cutting height when holding the rotating head a few inches above the ground while moving sideways or in an irregular pattern especially for a prolonged period of time. The string may also accidentally scalp the ground, causing a gouge, or even tear off tree bark if the operator moves too close to a tree.

Therefore, there is an established need for a convenient and labor-saving device that can be easily attached to a hand-held grass trimmer or brush cutter and that can help the grass trimmer or brush cutter to cut in a stable manner, while alleviating fatigue to the operator.

### SUMMARY OF THE INVENTION

The present invention is directed to a convenient and labor-saving wheeled support that facilitates the carrying and moving around of the grass trimmer or brush cutter. The grass trimmer wheeled support includes a support body to be attached to the grass trimmer or brush cutter, or integrally formed with a cutting head or safety guard of the grass trimmer or brush cutter, and at least two preferably omnidirectional swivel caster wheels attached to a bottom of the support body. The support body can have a variety of different shapes and structures. More than one wheeled support can also be used for one grass trimmer or brush cutter, for instance, one being attached to the shaft and one being attached to the safety guard, to increase the stability. In another example, two wheeled supports (having the same structure or different structures) may be attached to the shaft at different locations.

In a first implementation of the invention, a wheeled support for a grass trimmer or brush cutter includes a support body to be attached to the grass trimmer or brush cutter, and at least two wheels coupled to the support body, and rotatable in relation to the support body. The wheeled support can further include a connector for removably attaching the support body to a shaft of the grass trimmer or brush cutter. The connector can be arranged at a top end of the support body opposite to a bottom end of the support body at which the at least two wheels are coupled.

In another implementation of the invention, a grass trimmer or brush cutter assembly comprises a shaft, an engine at a proximal end of the shaft, and a trimmer or cutter head at a distal end of the shaft, the trimmer or cutter head having a safety guard. The grass trimmer or brush cutter assembly further includes at least two wheels rotatably affixed to a structure of the grass trimmer or brush cutter assembly. The wheels extend from the structure to allow the grass trimmer or brush cutter assembly to roll on a ground or surface. The structure can be removably attached to the shaft. Alternatively, the structure can be integrally formed in the trimmer or cutter head, for instance in the safety guard of the trimmer or cutter head.

In yet another implementation of the invention, a grass trimmer or brush cutter assembly comprises a shaft, an engine at a proximal end of the shaft, a trimmer or cutter head at a distal end of the shaft, and at least two wheels rotatably affixed to a structure of the grass trimmer or brush cutter assembly. The at least two wheels extend from the structure to allow the grass trimmer or brush cutter assembly to roll on a ground or surface. The at least two wheels include a first set of at least one wheel arranged on one side of the grass trimmer or brush cutter, and a second set of at least one wheel arranged on an opposite side of the grass trimmer or brush cutter. When observing the grass trimmer or brush cutter assembly in top plan view, the first set, second set and trimmer or cutter head are arranged in a triangle and the shaft extends between the first set and the second set, rendering the grass trimmer or brush cutter assembly stable, easy to carry and safe.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a perspective view of a grass trimmer provided with a wheeled support in accordance with a first embodiment of the present invention;

FIG. 2 presents a perspective view of the grass trimmer shaft and trimmer head, and the wheeled support of FIG. 1;

FIG. 3 presents a perspective view of the grass trimmer shaft and trimmer head, and the wheeled support of FIG. 1, shown exploded;

FIG. 4 presents a cross-sectional side elevation view of the assembly of FIG. 2;

FIG. 5 presents a perspective view of a grass trimmer provided with a wheeled support in accordance with a second embodiment of the present invention, the grass trimmer being shown only partially;

FIG. 6 presents a perspective view of a grass trimmer provided with a wheeled support in accordance with a third embodiment of the present invention, the grass trimmer being shown only partially;

FIG. 7 presents a perspective view of a grass trimmer provided with a wheeled support in accordance with a fourth embodiment of the present invention, the grass trimmer being shown only partially;

FIG. 8 presents a perspective view of a grass trimmer provided with a wheeled support in accordance with a fifth embodiment of the present invention, the grass trimmer being shown only partially;

FIG. 9 presents a perspective view of a grass trimmer provided with a wheeled support in accordance with a sixth embodiment of the present invention, the grass trimmer being shown only partially;

FIG. 10 presents a perspective view of a grass trimmer provided with a wheeled support in accordance with a seventh embodiment of the present invention, the grass trimmer being shown only partially;

FIG. 11 presents a perspective view of a grass trimmer provided with a wheeled support in accordance with an eighth embodiment of the present invention, the grass trimmer being shown only partially;

FIG. 12 presents a perspective view of a grass trimmer provided with a wheeled support in accordance with a ninth embodiment of the present invention, the grass trimmer being shown only partially;

FIG. 13 presents a perspective view of a grass trimmer provided with a wheeled support in accordance with a tenth embodiment of the present invention, the grass trimmer being shown only partially;

FIG. 14 presents a perspective view of a grass trimmer provided with a wheeled support in accordance with an eleventh embodiment of the present invention, the grass trimmer being shown only partially;

FIG. 15 presents a perspective view of a grass trimmer provided with a wheeled support in accordance with a twelfth embodiment of the present invention, the grass trimmer being shown only partially; and

FIG. 16 presents a top plan view of the grass trimmer and wheeled support of FIG. 15.

Like reference numerals refer to like parts throughout the several views of the drawings.

### DETAILED DESCRIPTION

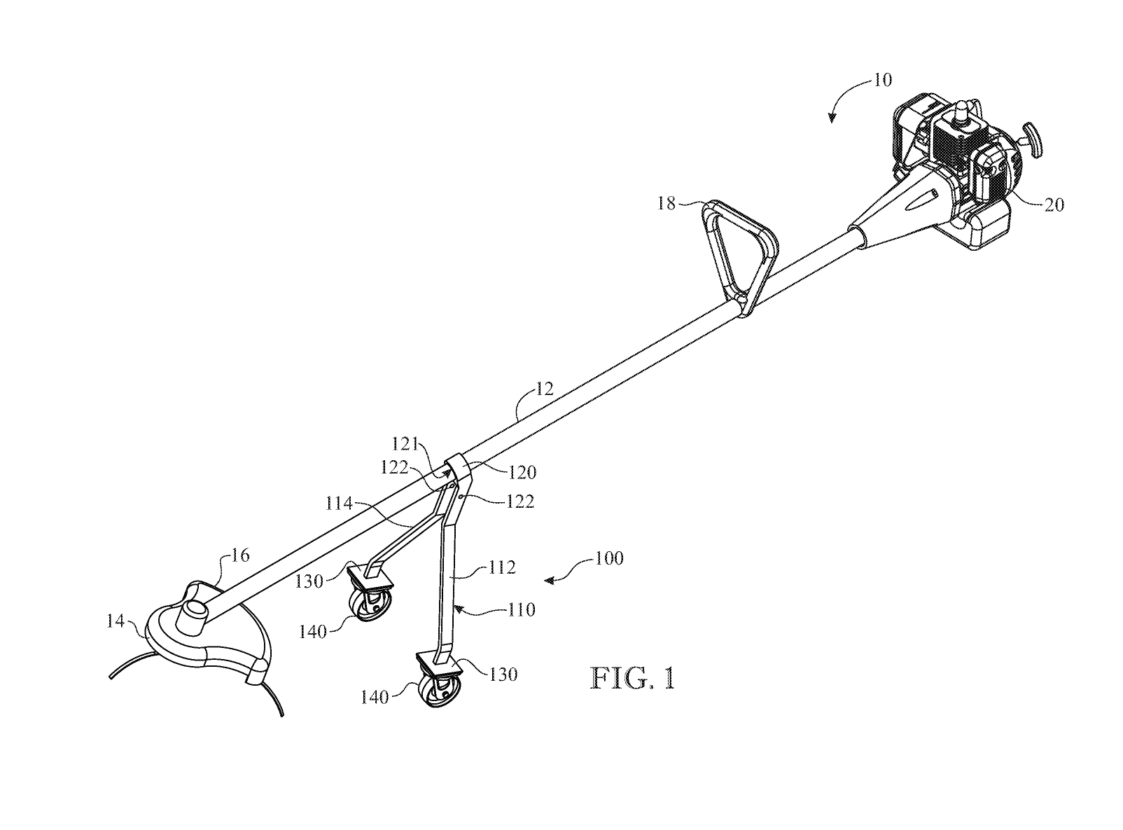

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a convenient and labor-saving wheeled support that is capable of being easily attached to a hand-held grass trimmer or brush cutter to provide support to the grass trimmer or brush cutter and also facilitate the moving around of the grass trimmer or brush cutter.

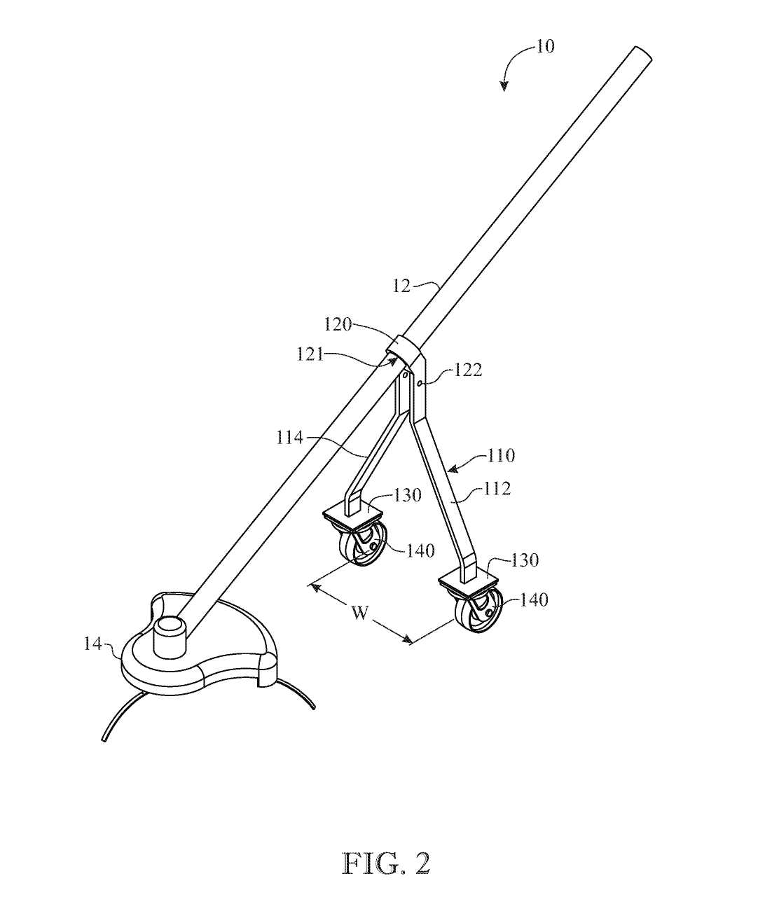

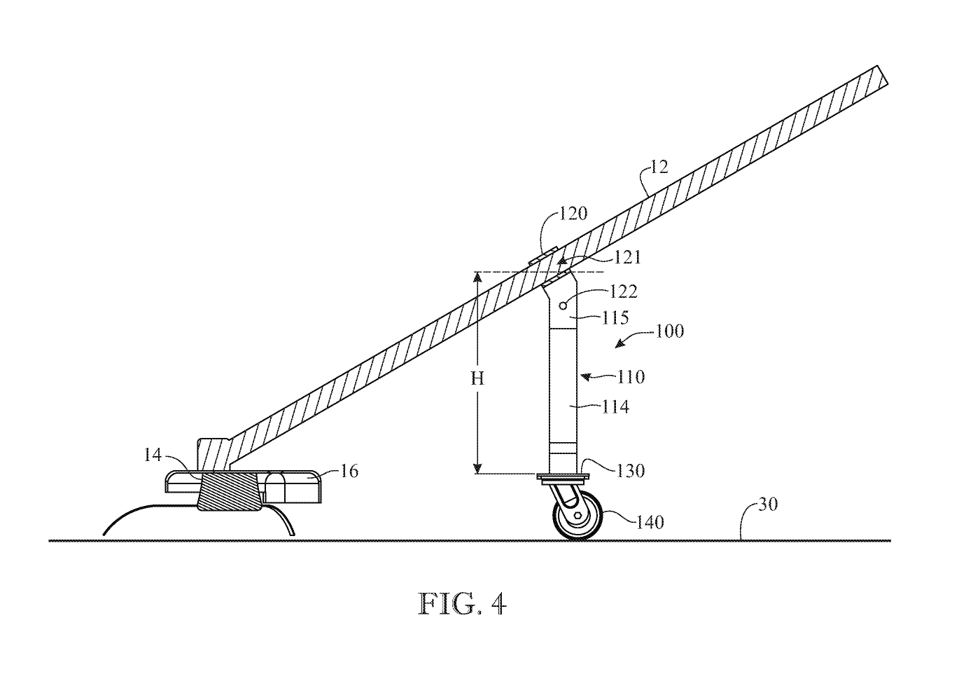

Referring now to FIGS. 1-4, a grass trimmer wheeled support 100 is illustrated in accordance with a first embodiment of the present invention. As shown, the grass trimmer wheeled support 100 is attached to a grass trimmer 10 that includes a shaft 12, a trimmer head 14 with a safety guard 16, a handle 18, and an engine 20. As can be best seen in the slightly enlarged, partial view of FIG. 2, the wheeled support 100 includes a support body 110 having a connector 120 at a top end thereof and brackets 130 at a bottom end thereof. The connector 120 is configured to couple to the shaft 12 of the grass trimmer 10 for attaching the wheeled support 100 to the grass trimmer 10. In turn, the brackets 130 provide a support for holding preferably caster wheels 140, which are arranged facing downwardly in order to rest on the ground 30, as shown in FIG. 4, while the grass trimmer 10 is being operated to cut grass. The caster wheels 140 preferably present an omnidirectional swivel relative to the support body 110. The grass trimmer wheeled support 100 thus makes it possible for the grass trimmer 10 to move in all directions while the support body 110 supports the shaft 12 of the grass trimmer 10 in an elevated position as shown in FIG. 4 without the user having to carry the grass trimmer 10 full weight.

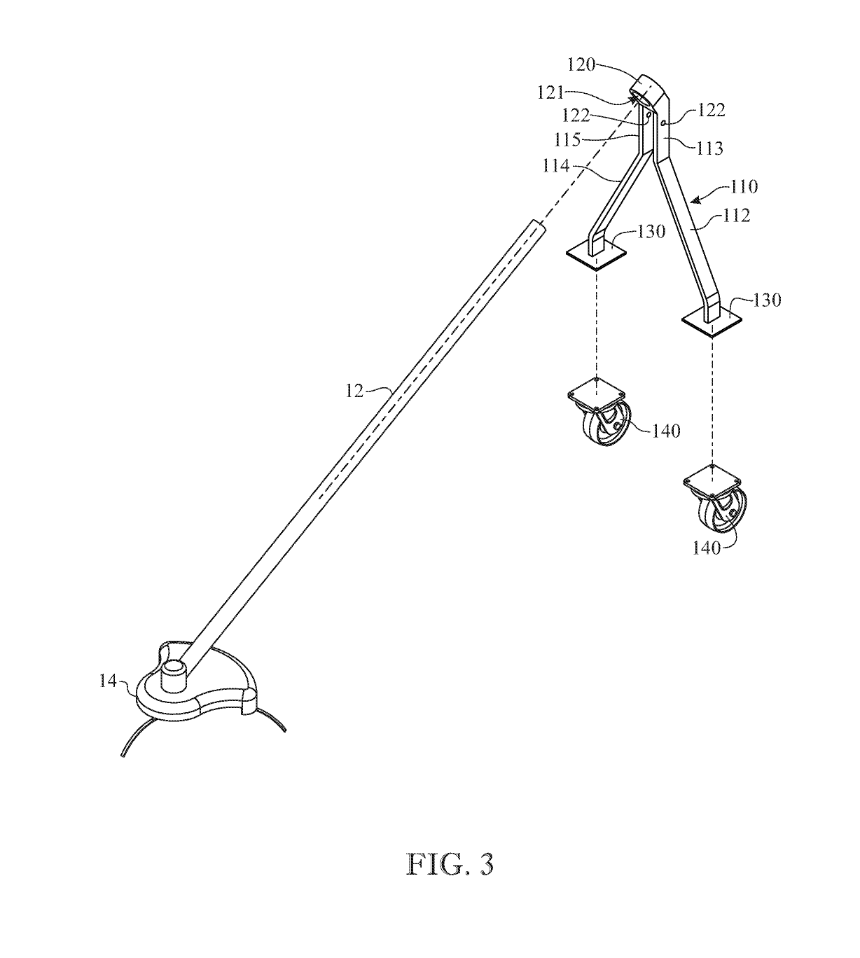

In the present embodiment, the support body 110 has an inverted Y-shape with two symmetrical divergent segments 112 and 114 extending from two corresponding symmetrical parallel top segments 113 and 115. The top segments 113 and 115, in turn, extend from an anchor or connector 120 defining a space 121 for receiving the shaft 12 of the grass trimmer 10. As can be more clearly seen in the exploded view of FIG. 3, the connector 120 allows for connecting the wheeled support 100 firmly to the shaft 12. As best shown in FIG. 4, the space 121 of the connector 120 can be arranged at an angle other than 90 degrees with the Y-shaped support body 110 in order for the shaft 12 to extend in a tilted fashion when the Y-shaped support body 110 stands vertically on the ground 30. The connector 120 can be formed, for instance and without limitation, as an open or slotted ring molded to adjust to the size and shape of the shaft 12. Pin holes 122 can be provided in the top segments 113 and 115 of the two divergent segments 112 and 114 so that a pin or bolt may be inserted through the pin holes 122 to more securely clamp the wheeled support 100 to the shaft 12.

The brackets 130 hold position of the swivel caster wheels 140 with a few inches distance W between the wheels 140 (see FIG. 2). Distance W can vary, for instance and without limitation, from 8 to 15 inches, providing a very stable horizontal position on the ground. With reference to FIG. 4, the vertical distance H between each bracket 130 and the mounting point of the connector 120 on the shaft 12 can vary, for instance and without limitation, from 8 to 12 inches, to allow the change of height on the grass string trimmer and brush cutter machines. The caster wheels 140 can each have a diameter of preferably at least 2.5 inches. In fact, the present embodiment is particularly convenient for large size swivel caster wheels (for example, 5-inch swivel caster wheels), which can make cutting grass on a yard with a rough terrain possible. Although the support body 110 of the wheeled support 100 may be made from various materials including a strong plastic, light aluminum is preferable. In turn, the swivel caster wheels 140 can be made of plastic, metal or combinations thereof.

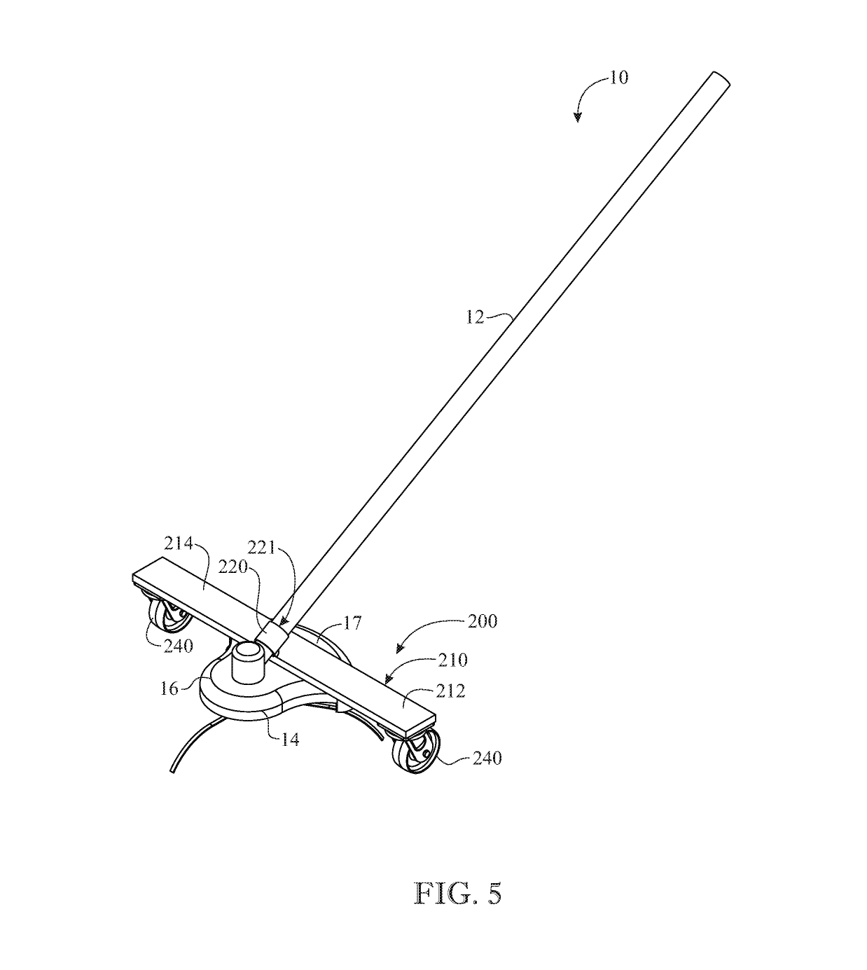

Referring now to FIG. 5, a grass trimmer wheeled support 200 is illustrated in accordance with a second embodiment of the present invention. As shown, the grass trimmer wheeled support 200 is arranged at or near an upper surface 17 of the safety guard 16 of the trimmer head 14. The grass trimmer wheeled support 200 includes a support body 210, the support body 210 generally including a central anchor or connector 220 and two opposing arms 212, 214. The opposing arms 212, 214 extend along a same longitudinal direction forming a straight, elongated plate or strip. The connector 220 extends from a top surface of the elongated plate or strip, and includes a space 221 for receiving the shaft 12 of the grass trimmer 10, the connector 220 thus providing a fastener for coupling the glass trimmer wheeled support 200 to the grass trimmer 10. The connector 220 can be attached to the shaft 12 by a frictional fitting, or by one or more screws, spring-biased locks, magnets and/or other applicable fasteners. Two preferably omnidirectional swivel caster wheels 240 are attached to and extend downward from each end of the support body 210, and more particularly from a bottom surface of the elongated strip or plate formed by the opposing arms 212, 214. This embodiment can be used for all grass string trimmers and brush cutters, but is particularly suitable for brush cutters of the type that comprises a metal blade.

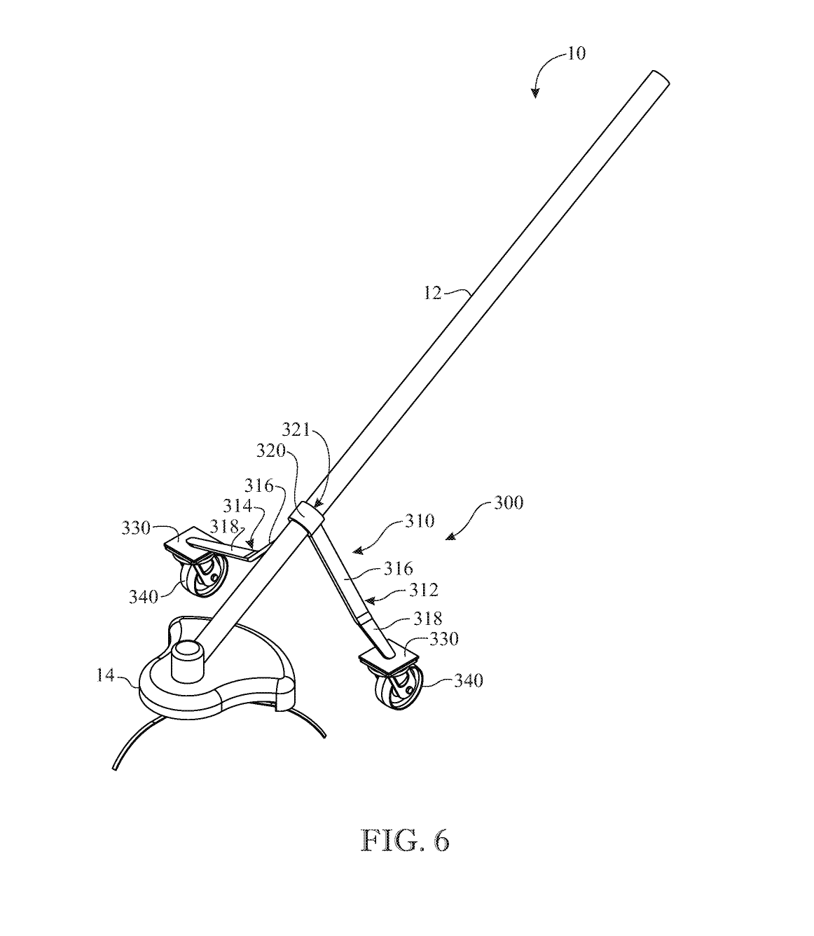

Referring now to FIG. 6, a grass trimmer wheeled support 300 is illustrated in accordance with a third embodiment of the present invention. As shown, the grass trimmer wheeled support 300 includes a support body 310 having an anchor or connector 320 at one end thereof. The connector 320 a space 321 for receiving the shaft 12 of the grass trimmer 10, and can be secured to the shaft 12 by a frictional fit or one or more fasteners or fastening mechanisms, similarly to the previous embodiments. At an opposite end of the support body 310, two spaced apart brackets 330 hold preferably omnidirectional swivel caster wheels 340. In this embodiment, the support body 310 has a vertical inverted V-shape with two divergent segments 312 and 314 extending symmetrically from the connector 320. Each divergent segment 312, 314 is comprised of a first portion 316 and a second portion 318. The first portions 316 of the divergent segments 312, 314 extend from the connector 320 forming a first angle, while the second portions 318 of the divergent segments 312, 314 extend from the first portions 316 forming a second angle which is greater than the first angle.

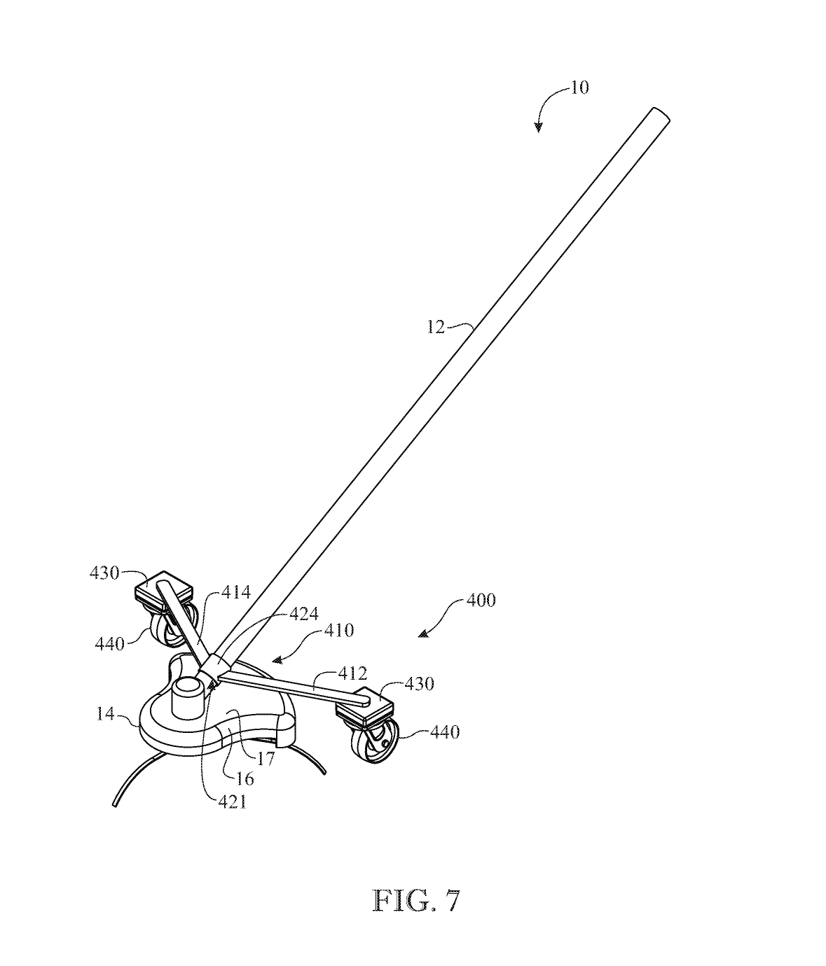

Referring now to FIG. 7, a grass trimmer wheeled support 400 is illustrated in accordance with a fourth embodiment of the present invention. As shown, the grass trimmer wheeled support 400 has a support body 410 that is attached via a connector 420 to the shaft 12 at a location very close to the trimmer head 14. The connector 420 defines a space 421 for receiving the shaft 12, and can be secured to the shaft 12 by a frictional fit or one or more fasteners or fastening mechanisms, similarly to the previous embodiments. Alternatively or additionally, the support body 410 can also be attached to the upper surface 17 of the safety guard 16 of the trimmer head 14. The support body 410 includes two symmetrical, rearwardly oriented arms 412 and 414, each of which is attached to the connector 420 at one end and attached to a bracket 430 at the other end. A preferably omnidirectional swivel caster wheel 440 is in turn affixed to a bottom surface of each bracket 430. The arms 412 and 414 form a wide angled, preferably horizontal V-shape to provide stability.

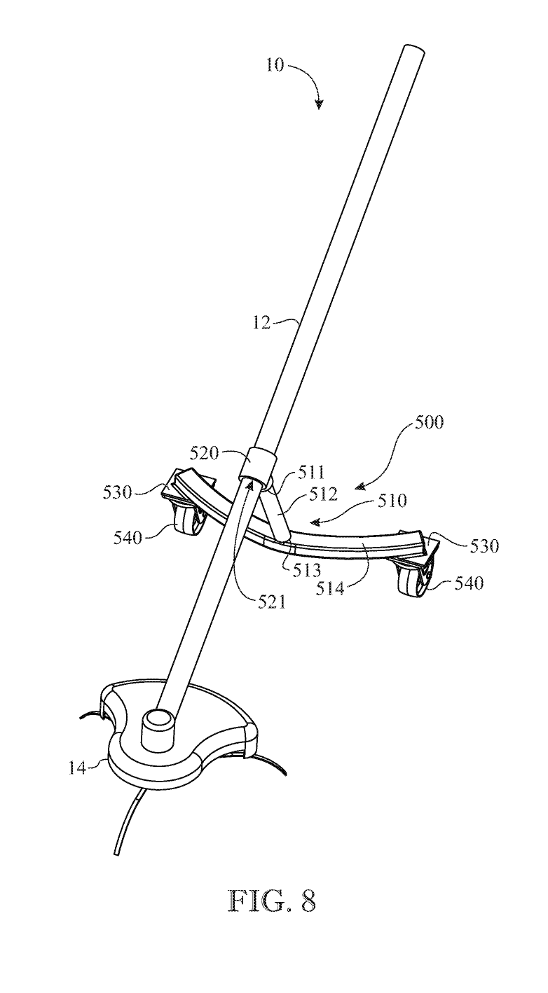

Referring now to FIG. 8, a grass trimmer wheeled support 500 is illustrated in accordance with a fifth embodiment of the present invention. As shown, the grass trimmer wheeled support 500 includes a support body 510 for attaching to the shaft 12 of the grass trimmer 10 and for holding two preferably omnidirectional swivel caster wheels 540. In this embodiment, the support body 510 includes a curved horizontal part 514 for holding the two preferably omnidirectional swivel caster wheels 540 through a bracket 530 at each end thereof. The support body 510 further includes a central post 512 having a top end 511 and a bottom end 513. An anchor or connector 520 extends from the top end 511 of the central post 512 for attaching to the shaft 12. The connector 520 defines a space 521 for receiving the shaft 12, and can be secured to the shaft 12 by a frictional fit or one or more fasteners or fastening mechanisms, similarly to the previous embodiments. In turn, the curved horizontal part 514 extends transversely from the bottom end 513 of the central post 512, so that the caster wheels 540 are arranged at opposite sides of the shaft 12 and spaced apart from the shaft 12, if observed in top plan view, to provide stability to the grass trimmer 10 and grass trimmer wheeled support 500 when assembled and in use.

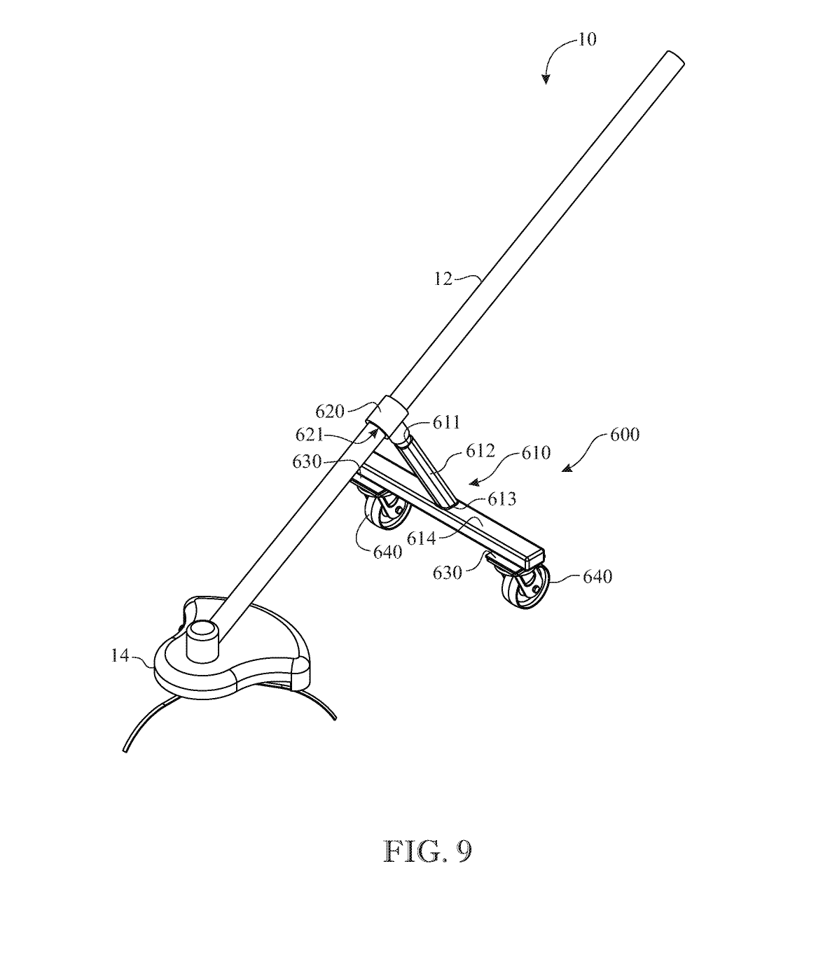

Referring now to FIG. 9, a grass trimmer wheeled support 600 is illustrated in accordance with a sixth embodiment of the present invention. As shown, the grass trimmer wheeled support 600 includes a support body 610 for attaching to the shaft 12 of the grass trimmer 10 and for holding two preferably omnidirectional swivel caster wheels 640. In this embodiment, the support body 610 is formed in an inverted T-shape, and includes a central post 612 and a bottom, straight horizontal crossbeam 614. The straight horizontal crossbeam 614 holds the two preferably omnidirectional swivel caster wheels 640 through a bracket 630 at each end thereof. The central post 612 is attached to the shaft 12 through an anchor or connector 620 at its top end 611 and to the straight horizontal crossbeam 614 at its bottom end 613. The connector 620 defines an elongated space 621 for receiving the shaft 12, and can be secured to the shaft 12 by a frictional fit or one or more fasteners or fastening mechanisms, similarly to the previous embodiments. The elongated space 621 is arranged generally perpendicularly to the T-shaped support body 610, so that the shaft 12 extends perpendicularly to the vertical post 612 when the grass trimmer wheeled support 600 is assembled on the grass trimmer 10.

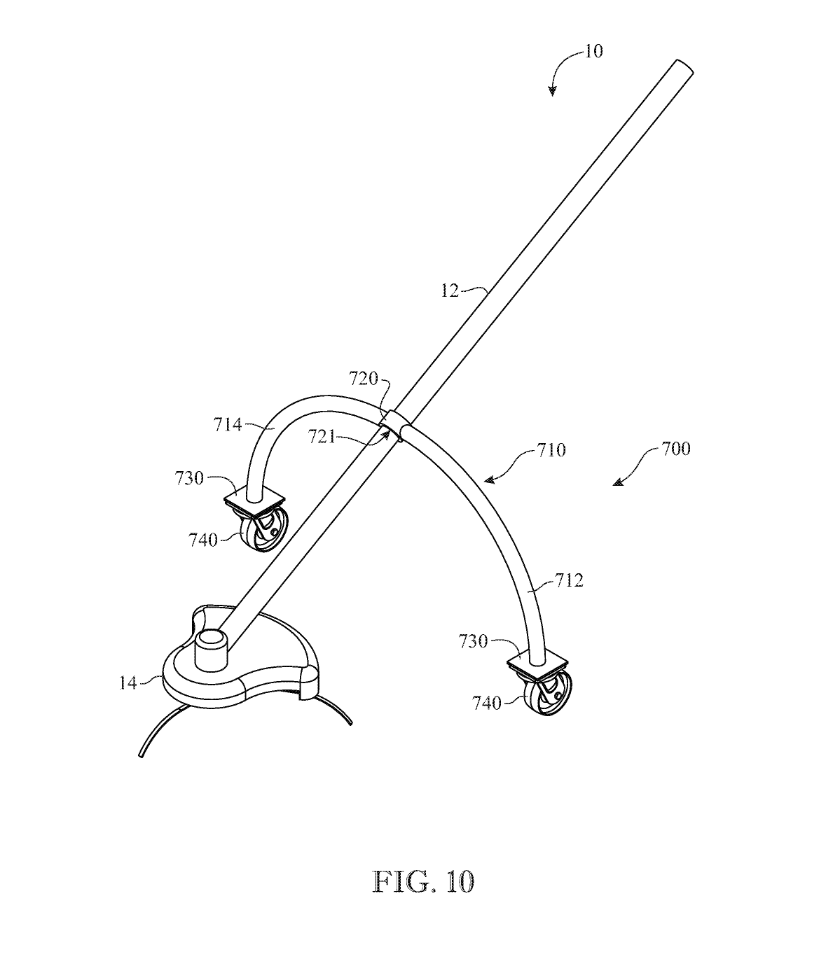

Referring now to FIG. 10, a grass trimmer wheeled support 700 is illustrated in accordance with a seventh embodiment of the present invention. As shown, the grass trimmer wheeled support 700 includes a support body 710 having at one end an anchor or connector 720 for attaching the wheeled support 700 to the shaft 12 of the grass trimmer 10 and at the other end brackets 730 for holding preferably omnidirectional swivel caster wheels 740. In this embodiment, the support body 710 has a curved shape, such as an arc or half oval, with two symmetrical curved arms 712 and 714. The two curved arms 712 and 714 extend outwardly and coplanarly from the connector 720 to create the curved support body 710. The connector 720 defines a space 721 for receiving the shaft 12, and can be secured to the shaft 12 by a frictional fit or one or more fasteners or fastening mechanisms, similarly to the previous embodiments. The space 721 is configured so that the shaft 12, when fitted in the space 721, is arranged at an angle less than 90 degrees with a transverse plane encompassing the curved arms 712 and 714. This design provides more horizontal stability to larger swivel caster wheels.

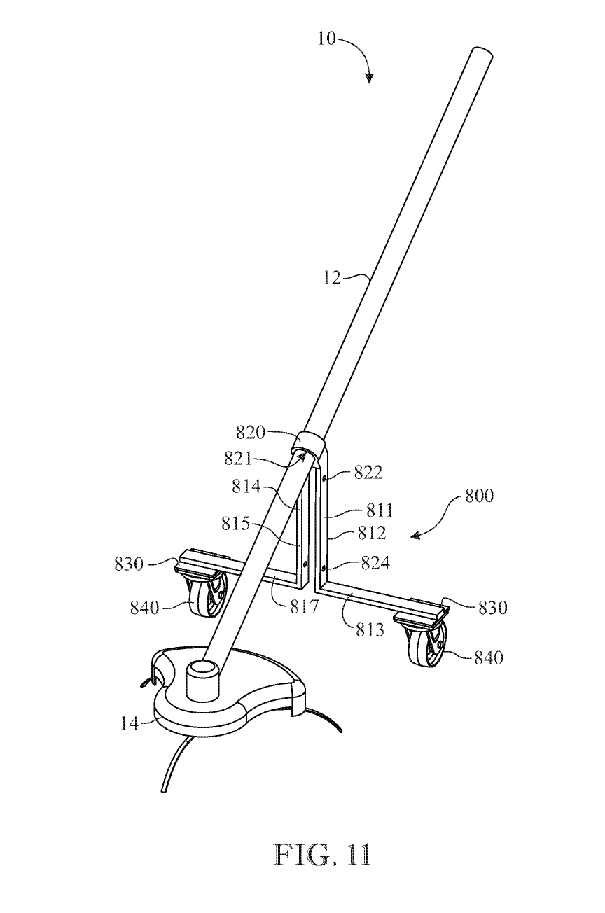

Referring now to FIG. 11, a grass trimmer wheeled support 800 is illustrated in accordance with an eighth embodiment of the present invention. As shown, the grass trimmer wheeled support 800 includes a support body 810 having at one end an anchor or connector 820 for attaching the wheeled support 800 to the shaft 12 of the grass trimmer 10 and at the other end brackets 830 for holding preferably omnidirectional swivel caster wheels 840. In this embodiment, the support body 810 has a vertical inverted T-shape with two symmetrical parts 812 and 814 each having a vertical section 811, 815 and a horizontal section 813, 817. The vertical sections 811 and 815 extend from the connector 820. The connector 820 can be an open or slotted ring; pin holes 822 and 824 can be provided in the vertical sections 811 and 815 of the two parts 812 and 814 so that corresponding pins or bolts can be inserted through the pin holes 822 and 824 to tighten the connector 820 against the shaft 12 and securely clamp the wheeled support 800 to the shaft 12. The connector 820 defines a space 821 for receiving the shaft 12. The space 821 is configured so that the shaft 12, when fitted in the space 821, forms an angle other than 90 degrees with the T-shaped support body 810, as shown. This design is particularly convenient for large size swivel caster wheels (for example, 5-inch swivel caster wheels).

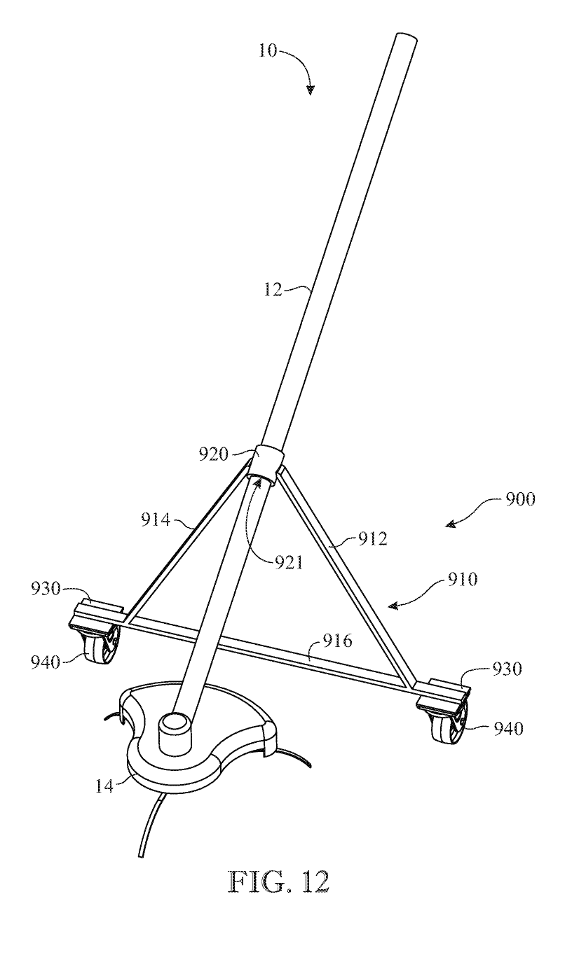

Referring now to FIG. 12, a grass trimmer wheeled support 900 is illustrated in accordance with a ninth embodiment of the present invention. As shown, the grass trimmer wheeled support 900 includes a support body 910 having at one end an anchor or connector 920 for attaching the wheeled support 900 to the shaft 12 of the grass trimmer 10 and at the other end brackets 930 for holding preferably omnidirectional swivel caster wheels 940. In this embodiment, the support body 910 has a triangular shape with two symmetrical oblique segments 912 and 914 and a horizontal segment 916. The top ends of the two oblique segments 912 and 914 extend from the connector 920. The bottom ends of the two oblique segments 912 and 914 are attached to the horizontal segment 916 which in turn holds the preferably omnidirectional swivel caster wheels 940 at each of its end through a respective bracket 930. The connector 920 defines a space 921 for receiving the shaft 12, and can be secured to the shaft 12 by a frictional fit or one or more fasteners or fastening mechanisms, similarly to the previous embodiments. Similarly to the previous embodiments, the space 921 is configured so that the shaft 12, when fitted in the space 921, forms an angle other than 90 degrees with the triangular support body 910, and so that the support body 910 is arranged generally vertically when operating the grass trimmer 10. The triangle structure of the support body 910 provides a strong support and thus is ideal for wheels 940 having a large distance therebetween.

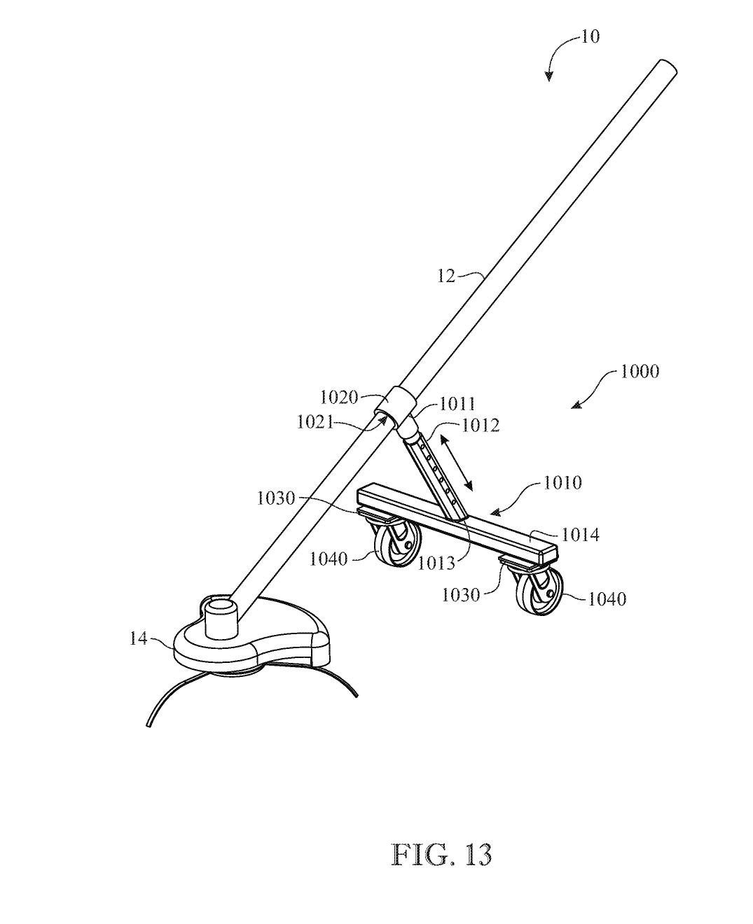

Referring now to FIG. 13, a grass trimmer wheeled support 1000 is illustrated in accordance with a tenth embodiment of the present invention. As shown, the grass trimmer wheeled support 1000 includes a support body 1010 for attaching to the shaft 12 of the grass trimmer 10 and for holding two preferably omnidirectional swivel caster wheels 1040. In this embodiment, the support body 1010 includes a straight horizontal crossbeam 1014 for holding the two preferably omnidirectional swivel caster wheels 1040 through a bracket 1030 at each end thereof and a central post 1012 for attaching to the shaft 12 through an anchor or connector 1020 at its top end 1011 and to the straight horizontal crossbeam 1014 at its bottom end 1013. This embodiment is similar to the embodiment as shown in FIG. 9 except that in this embodiment the central post 1012 has a telescopic, length-adjustable structure.

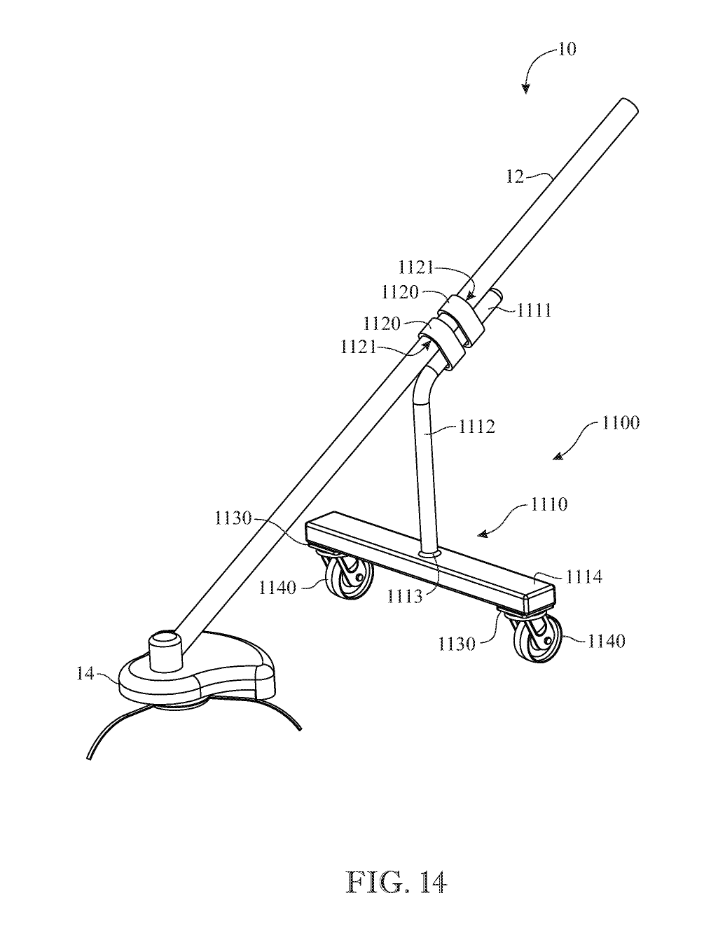

Referring now to FIG. 14, a grass trimmer wheeled support 1100 is illustrated in accordance with an eleventh embodiment of the present invention. As shown, the grass trimmer wheeled support 1100 includes a support body 1110 for attaching to the shaft 12 of the grass trimmer 10 and for holding two preferably omnidirectional swivel caster wheels 1140. In this embodiment, the support body 1110 includes a straight horizontal crossbeam 1114 for holding the two preferably omnidirectional swivel caster wheels 1140 through a bracket 1130 at each end thereof and a central post 1112 having a top angled section 1111 for attaching to the shaft 12. In turn, the straight horizontal crossbeam 1114 extends transversely from a bottom 1113 of the central post 1112 opposite to the top angled section 1111. This embodiment is very similar to the embodiment as shown in FIG. 9 except that in this embodiment the top angled section 1111 of the central post 1112 is attached to the shaft 12 using two heavy duty quick release clamps or connectors 1120. The connector 1020 defines a space 1021 for receiving the shaft 12. Similarly to previous embodiments, the space 1021 is configured to receive the shaft 12 at an angle of less than 90 degrees with respect to a T-shaped structure formed by the central post 1112 and the straight horizontal crossbeam 1114. To further assist in supporting the weight of the grass trimmer 10, the central post 1112 can be arranged vertically, as shown, when the grass trimmer 10 and grass trimmer wheeled support 1000 are assembled and in use (i.e. when the caster wheels 1140 are resting on the ground and the trimmer head 14 is near or on the grass).

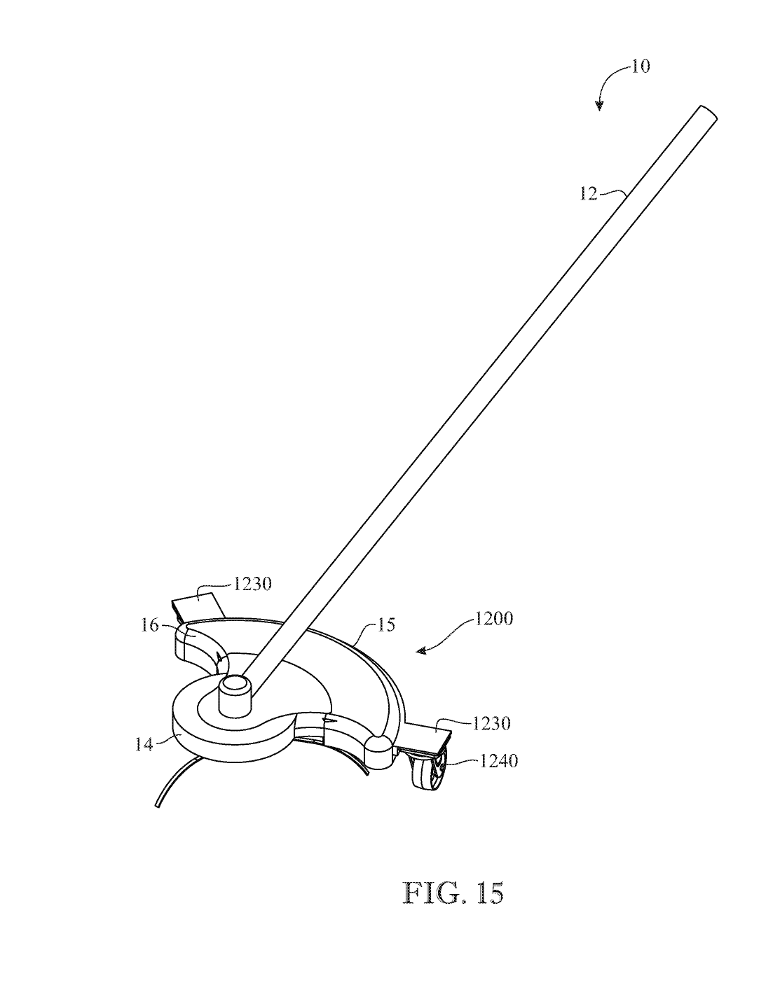

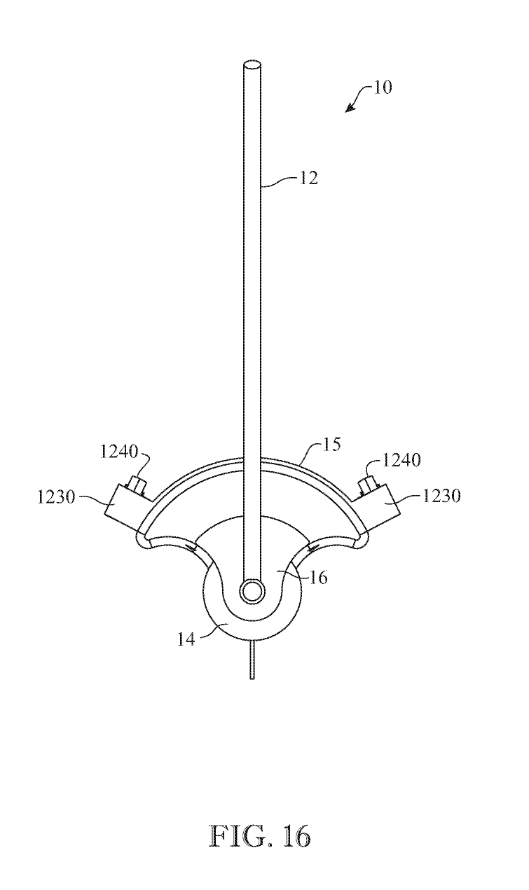

Referring now to FIGS. 15 and 16, a grass trimmer wheeled support 1200 is illustrated in accordance with a twelfth embodiment of the present invention. As shown, in this embodiment, the grass trimmer wheeled support 1200 does not have a support body. Instead, the grass trimmer wheeled support 1200 comprises two preferably omnidirectional swivel caster wheels 1240 mounted on an edge 15 of the safety guard 16 through brackets 1230. As can be more clearly seen in FIG. 16, the two preferably omnidirectional swivel caster wheels 1240 are located at each transverse side of the edge 15 so that they can be horizontally further apart as possible.

As shown in the various embodiments provided herein, the grass trimmer or brush cutter can be provided with two or more wheels to facilitate operating the grass trimmer or brush cutter. The two or more wheels are divided into a first set of at least one wheel arranged on one side of the grass trimmer or brush cutter and a second set of at least one wheel arranged on an opposite side of the grass trimmer or brush cutter, when observing the grass trimmer or brush cutter in top plan view. The first set of at least one wheel, the second set of at least one wheel, and the trimmer or cutter head are arranged in a triangle when observing the grass trimmer or brush cutter assembly in top plan view. In addition, in top plan view, the shaft extends between the first set and the second set, the first and second set arranged on opposite sides of the shaft and in a spaced-apart relationship with the shaft. This triangular arrangement renders operation of the grass trimmer or brush cutter convenient and safe, as the grass trimmer or brush cutter will rest safely and stably on the two rear sets of wheels (rear in relation to the trimmer or cutter head, thanks to the triangular arrangement) while the trimmer or cutter head is brought close to the grass for trimming.

The wheeled support of the present invention can be attached to or provided with a variety of different types, models, and brands of grass trimmers and brush cutter machines, whether they have a straight shaft or curved shaft, whether they use strings or blades for cutting, and whether they are electrical or gas-powered. In order to provide more stability, two wheeled supports may be attached to a grass trimmer. For example, one is attached to the shaft while the other one is attached to the safety guard. Alternatively, both of the two wheeled supports (having the same structure or different structures) may be attached to the shaft at different locations. The combination of two wheeled supports promotes maximum horizontal stability, having a total of four preferably omnidirectional swivel caster wheels.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A wheeled support for a grass trimmer or brush cutter, comprising:
a support body to be attached to the grass trimmer or brush cutter; and
at least two wheels coupled to the support body, and rotatable in relation to the support body.

2. The wheeled support of claim 1, further comprising:
a connector for removably attaching the support body to a shaft of the grass trimmer or brush cutter, the connector arranged at a top end of the support body opposite to a bottom end of the support body at which the at least two wheels are coupled.

3. The wheeled support of claim 2, wherein the support body has an inverted Y-shape with two top segments and two symmetrical divergent segments, wherein the two top segments extend from the connector in a parallel and spaced apart relationship with one another, and the two symmetrical divergent segments extend respectively from the two top segments.

4. The wheeled support of claim 3, wherein pin holes are formed in the two top segments for a pin or bolt to be inserted through the pin holes for tightening the connector.

5. The wheeled support of claim 2, wherein the support body has an inverted V-shape with two symmetrical divergent segments extending from the connector.

6. The wheeled support of claim 2, wherein the support body has a V-shape with two symmetrical divergent segments extending from the connector, each segment comprising a distal end attached to a wheel of the at least two wheels, the connector being configured to attach to the shaft at a location close to a trimmer head of the grass trimmer.

7. The wheeled support of claim 2, wherein the support body comprises a curved horizontal part and a central post, the curved horizontal part carrying the at least two wheels and the central post extending upwardly from the curved horizontal part, and further wherein the connector is arranged at a top end of the central post.

8. The wheeled support of claim 2, wherein the support body comprises a straight horizontal crossbeam and a central post, the straight horizontal crossbeam carrying the at least two wheels and the central post extending upwardly from the straight horizontal crossbeam, and further wherein the connector is arranged at a top end of the central post.

9. The wheeled support of claim 8, wherein the central post comprises a telescopic, length-adjustable structure.

10. The wheeled support of claim 2, wherein the support body has an arched shape with two symmetrical curved arms extending downwardly and oppositely from the connector.

11. The wheeled support of claim 2, wherein the support body has a vertical inverted T-shape with two symmetrical parts, each part having a vertical section and a horizontal section, the vertical sections extending downwardly from the connector, and the horizontal sections extending from the respective vertical sections, oppositely to and away from one another.

12. The wheeled support of claim 11, wherein pin holes are provided in the vertical sections of the two parts for one or more pins or bolts to be inserted through the pin holes for securing the clamp.

13. The wheeled support of claim 2, wherein the support body has a triangle shape with two symmetrical oblique segments and a horizontal segment, with top ends of the two oblique segments extending from the connector, and with bottom ends of the two oblique segments being respectively attached to two opposite ends of the horizontal segment, and further wherein the horizontal segment carries the at least two wheels at each of the two opposite ends thereof.

14. The wheeled support of claim 2, wherein the support body comprises a straight horizontal crossbeam carrying the at least two wheels, a central post extending upward from the straight horizontal crossbeam and provided with a top angled section a top end thereof, the top angled section of the central post being attachable to the shaft via the connector.

15. The wheeled support of claim 1, wherein the support body is comprised in a safety guard of a trimmer head of the grass trimmer or of a cutter head of the brush cutter.

16. The wheeled support of claim 1, wherein the at least two wheels comprise a first set of at least one wheel arranged on one side of the grass trimmer or brush cutter and a second set of at least one wheel arranged on an opposite side of the grass trimmer or brush cutter, the first set and the second set separated from one another a horizontal distance of 8 to 15 inches, and further wherein a vertical distance between a top end of the at least two wheels and a mounting point of the support body to a shaft of the grass trimmer or brush cutter ranges from 8 to 12 inches.

17. A grass trimmer or brush cutter assembly, comprising:
a shaft;
an engine at a proximal end of the shaft;
a trimmer or cutterhead at a distal end of the shaft, the trimmer or cutter head having a safety guard; and
at least two wheels rotatably affixed to a structure of the grass trimmer or brush cutter assembly and extending from the structure for rolling on a ground or surface.

18. The grass trimmer or brush cutter assembly of claim 17, wherein the structure is removably attached to the shaft.

19. The grass trimmer or brush cutter assembly of claim 17, wherein the structure is integrally formed in the trimmer or cutter head.

20. A grass trimmer or brush cutter assembly, comprising:
a shaft;
an engine at a proximal end of the shaft;
a trimmer or cutter head at a distal end of the shaft; and
at least two wheels rotatably affixed to a structure of the grass trimmer or brush cutter assembly, the at least two wheels extending from the structure for rolling on a ground or surface; wherein
the at least two wheels comprise a first set of at least one wheel arranged on one side of the grass trimmer or brush cutter and a second set of at least one wheel arranged on an opposite side of the grass trimmer or brush cutter; and further wherein
when observing the grass trimmer or brush cutter assembly in top plan view, the first set, second set and trimmer or cutter head are arranged in a triangle and the shaft extends between the first set and the second set.
